(19) United States
(12) Patent Application Publication
(10) Pub. No.: US 2025/0387802 A1
(43) Pub. Date: Dec. 25, 2025

(54) VIBRATION SCREEN CONDITION MONITORING METHOD AND VIBRATION SCREEN CONDITION MONITORING SYSTEM

(71) Applicant: Aktiebolaget SKF

(72) Inventors: Kai ZHANG, Shanghai (CN); Kaihuan ZHANG, Hangzhou (CN); Xiang ZHOU, Tianjin (CN)

(73) Assignee: Aktiebolaget SKF, (omitted)

(21) Appl. No.: 19/240,049

(22) Filed: Jun. 17, 2025

(30) Foreign Application Priority Data
Jun. 24, 2024 (CN) 202410821908.2

(51) Int. Cl. B07B 1/42

(52) U.S. Cl. CPC B07B 1/42

(57) ABSTRACT

The present disclosure relates to a method of monitoring a condition of a vibration screen and a vibration screen condition monitoring system. The vibration screen condition monitoring method includes obtaining screen body vibration data; determining whether the screen body vibration is abnormal based on the screen body vibration data; determining whether the exciter vibration is abnormal base on the exciter vibration data; and determining that the vibration screen has a fault when either the screen body vibration or the exciter vibration is abnormal.

### CROSS-REFERENCE TO RELATED APPLICATION

This application claims priority to Chinese Application No. 202410821908.2, filed Jun. 24, 2024, the entirety of which is hereby incorporated by reference.

### FIELD

The present disclosure relates to vibration screen condition monitoring method and vibration screen condition monitoring system.

### BACKGROUND

In the field of industrial production, vibration screen, as a key technical equipment, is widely used in many industries such as mining, chemical industry, food processing, etc., especially in mining system plays a vital role. Its core function is to classify solid particles by size or weight using vibration principle, and realize key process steps such as grading, impurity removal, screening and filtration of the material.

Since the vibration screen is often in harsh conditions and high-load working environments, the probability of its failure is relatively high. These failures may not only lead to interruptions in the production process, but also cause several chain problems. Since the discovery of vibration screen fault is often not timely and accurate enough, the implementation of effective condition monitoring and intelligent early warning mechanisms is particularly crucial.

However, at present, the fault monitoring system for vibration screen is not well-developed, and faults are usually only detected and handled manually after they occur. This situation limits the response speed for faults and the efficiency of maintenance.

In view of this, it is of great significance to develop a new vibration screen monitoring and fault diagnosis system to solve the above problems for improving the reliability of vibration screen and reducing maintenance costs.

### SUMMARY

To address the aforementioned problems and needs, the present disclosure proposes a vibration screen condition monitoring method and a vibration screen condition monitoring system, which solves the above-mentioned problems and brings additional technical effects by adopting the following technical features.

On one hand, the present disclosure proposes a vibration screen condition monitoring method, including: obtaining screen body vibration data; obtaining exciter vibration data; determining whether the screen body vibration is abnormal based on said screen body vibration data; determining whether the exciter vibration is abnormal base on said exciter vibration data; determining that said vibration screen has a fault when either the screen body vibration or the exciter vibration is abnormal.

According to a preferred solution, obtaining the screen body vibration data includes obtaining first acceleration data from a screen body sensor, said first acceleration data reflecting the acceleration of the screen body in a plane; and determining whether the screen body vibration is abnormal based on said screen body vibration data includes: converting said first acceleration data into screen body vibration position data; obtaining the motion trajectory of the screen body in said plane based on said screen body vibration position data; obtaining trajectory parameter data from said motion trajectory; and comparing said trajectory parameter data with corresponding trajectory parameter thresholds and determining that said vibration screen has a fault if said trajectory parameter data exceeds the corresponding trajectory parameter thresholds.

According to a preferred solution, said trajectory parameter data includes an ellipse major axis dimension, an ellipse minor axis dimension, and an ellipse inclination angle.

According to a preferred solution, converting said first acceleration data into the screen body vibration position data includes integrating said first acceleration data twice to obtain the screen body vibration position data.

According to a preferred solution, obtaining the screen body vibration data includes obtaining a second acceleration data from the screen body sensor, said second acceleration data reflecting the acceleration of the screen body in a swing direction perpendicular to said plane; and determining whether the screen body vibration is abnormal based on said screen body vibration data includes: converting said second acceleration data into screen body swing position data; obtaining a plurality of maximum swing positions and initial phases of the screen body in said swing direction based on said screen body swing position data; determining whether the vibration screen has a fault based on said plurality of maximum swing positions and initial phases.

According to a preferred solution, determining whether the vibration screen has a fault based on said plurality of maximum swing positions and initial phases includes: comparing said plurality of maximum swing positions with a maximum swing threshold, and comparing said plurality of initial phases in synchronization, and determining that said vibration screen has a fault if the maximum swing position exceeds the maximum swing threshold or the synchronization of said plurality of phase data is lower than a synchronization threshold.

According to a preferred solution, said exciter vibration data is exciter acceleration data from an exciter sensor.

According to a preferred solution, determining whether the exciter vibration is abnormal based on said exciter vibration data includes: obtaining a exciter rotation frequency based on said exciter acceleration data; obtaining an envelope spectrum of the exciter acceleration data based on said exciter acceleration data; and comparing the spectrum value corresponding to said exciter rotation frequency in said envelope spectrum with a spectrum threshold, and determining that said vibration screen has a fault if said spectrum value exceeds said spectrum threshold.

According to a preferred solution, determining whether the screen body vibration is abnormal based on said screen body vibration data includes preprocessing said screen body vibration data, and/or determining whether the exciter vibration is abnormal based on said exciter vibration data includes preprocessing said exciter vibration data.

The present disclosure also proposes a vibration screen condition monitoring system, including: one or more screen body sensors located on the screen body of the vibration screen; one or more exciter sensors located on the exciter of the vibration screen; a state determination unit that receives screen body vibration data from said one or more screen body sensors and receives exciter vibration data from said one or more exciter sensors, wherein said state determination unit determines whether the screen body vibration is abnormal based on said screen body vibration data and determines whether the exciter vibration is abnormal based on said exciter vibration data, and determines that said vibration screen has a fault when either the screen body vibration or the exciter vibration is abnormal.

Hereinafter, optimal embodiments for implementing the present disclosure will be described in more detail with the accompanying drawings so that the features and advantages of the present disclosure can be readily understood.

### BRIEF DESCRIPTION OF THE DRAWINGS

In order to more clearly explain the technical solution of the embodiment of the present disclosure, the drawings of the embodiment of the present disclosure will be briefly introduced below. The drawings are only used to illustrate some embodiments of the present disclosure, and do not limit the embodiments of the present disclosure thereto.

FIG. 1 shows an exemplary vibration screen;

FIG. 2 shows the main steps of the vibration screen condition monitoring method proposed in this disclosure;

FIG. 3 shows a preferred step of determining whether the screen body vibration is abnormal based on said screen body vibration data;

FIG. 4 shows a preferred step of determining whether the screen body vibration is abnormal based on said exciter vibration data;

FIG. 5A shows the screen body motion trajectory under the normal operation state of the vibration screen;

FIG. 5B shows the screen body motion trajectory under a certain faulty operation state of the vibration screen;

FIG. 6 shows an exemplary fault state in which the ellipse major axis dimension exceeds a threshold;

FIG. 7 shows the envelope waveform and the envelope spectrum; and

FIG. 8 shows the vibration screen condition monitoring system of the present disclosure.

### DETAILED DESCRIPTION

In order to make the purpose, technical solutions, and advantages of the technical solutions of the present disclosure clearer, the technical solutions of the embodiments of the present disclosure will be described clearly and completely below with reference to the drawings of specific embodiments of the present disclosure. In the figures, identical reference numerals represent identical components. It should be noted that the described embodiments are only some embodiments of the present disclosure, but not all embodiments. Based on the described embodiments of the present disclosure, all other embodiments obtained by those skilled in the art without creative work fall within the scope of protection of the present disclosure.

Compared with the embodiments shown in the figures, feasible embodiments within the protection scope of the present disclosure may have fewer components, other components not shown in the figures, different components, differently arranged components, or differently connected components, etc. Furthermore, two or more components in the figures may be implemented in a single component, or a single component shown in the figures may be implemented as a plurality of separate components.

Unless otherwise defined, technical terms or scientific terms used herein should have the ordinary meaning understood by person of general skill in the art to which this disclosure belongs. The terms “first,” “second,” and the like used in the specification and claims of this disclosure do not indicate any order, quantity, or importance, but are only used to distinguish different components. Similarly, terms “a” or “an” and the like do not necessarily indicate a quantitative limitation. The terms “comprising” or “including” and the like indicate that the element or item preceded by the terms encompass the element or item listed thereafter and their equivalents, without excluding other elements or items. The terms “connected” or “coupled” and the like are not limited to physical or mechanical connections, but may include electrical connections, whether direct or indirect. Terms “upper”, “lower”, “left”, “right”, etc. are used only to indicate a relative positional relationship, which may change accordingly if the absolute position of the described object changes.

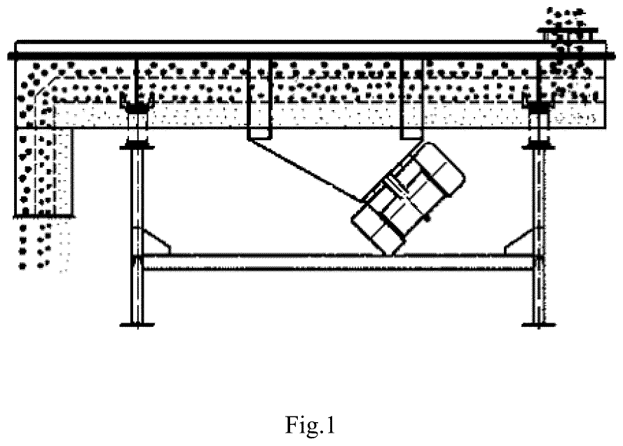

The vibration screen generally includes a vibration screen body and an exciter, which together realize the vibration screening process. The screen body is used to withstand the vibration during the screening process and the weight of the material, which is equipped with screen mesh or screen plate with screen holes, through which the separation of different sizes of particles is realized. The screen body generally includes a material inlet and a material outlet. The material enters the inside of the screen body through the material inlet, sometimes equipped with a feeder or funnel, which ensures that the material can be uniformly distributed on the screen surface, thus improving screening efficiency and preventing material accumulation. The material outlet is used to guide the screened material out. Depending on the varying particle sizes of the screened material, the outlet may include multiple discharge ports of different dimensions, allowing particles of varying sizes to be discharged separately. These outlets are usually located on lower portion or side portions of the screen body. FIG. 1 shows an exemplary vibration screen and the material inlet and material outlet of its screen body. In this exemplary embodiment, the material enters the screen body from a material inlet located on the right side, while the remaining material after screening exits from a material outlet located on the left side.

The exciter is a component that generates vibration. The exciter can be installed below or on both sides of the screen body and is used to provide power to make the screen body vibrate. The exciter can typically be driven by a motor, generating periodic excitation force, through, for example, the rotation of an eccentric wheel, this force is transmitted directly or indirectly to the screen body, causing the material to jump and move forward on the surface of the screen body to achieve particle size classification. The exciter has bearings to support the rotation of the eccentric wheel, reducing friction and ensuring its stable operation. The exciter determines the vibration characteristics of the vibration screen, including amplitude, frequency and vibration direction.

In order to realize the condition monitoring of the vibration screen, the present disclosure proposes that one or more screen body sensors are arranged on the screen body to obtain vibration data of the screen body in real time. The present disclosure does not limit the position and number of screen body sensors. Preferably, one screen body sensor is arranged on each side of the material inlet of the screen body, and one screen body sensor is arranged on each side of the material outlet to comprehensively monitor the vibration cases of each position of the vibration screen body. Alternatively, one screen body sensor may be provided on each of the left and right sides of the screen body. Arranging sensors on the screen body, the vibration of the screen body can be directly obtained, and then the state of the vibration screen can be obtained.

Furthermore, the present disclosure proposes that one or more exciter sensors are arranged on the exciter of the vibration screen to obtain vibration data of the exciter in real time. Since the vibration of the screen body is generated by the exciter, monitoring the exciter's condition can find and deal with potential vibration screen failures in time, reducing production interruptions and maintenance costs. The number of the exciter sensors is not limited, and for example, one, two, or more sensors may be provided on the exciter. In addition, the specific position of the exciter sensor is not limited. Preferably, the exciter sensor is located on a bearing of support cam of the exciter. Furthermore, the exciter sensor may also be located on a component directly driven by the power output of the exciter.

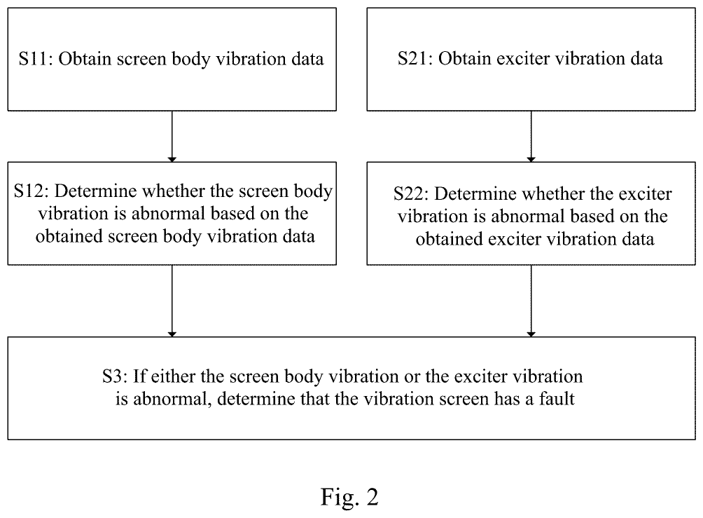

FIG. 2 illustrates the proposed disclosure the main steps of a method for monitoring the state of a vibration screen.

First, in step S11, screen body vibration data is obtained. The screen body vibration data indicates data reflecting the vibration case of the screen body of the vibration screen, which may, for example, come from one or more screen body sensors mounted on the screen body. In a case where a plurality of screen body sensors are provided on the screen, obtaining the screen vibration data may include obtaining data of each screen body sensor. In some implementations, vibration determination and failure evaluation may be performed separately based on the vibration data of each screen body sensor. The screen body vibration data may include data such as acceleration, velocity, displacement, and the like. In a preferred solution of the present disclosure, the screen body sensor data is acceleration data that reflects the acceleration of the movement of the screen.

In step S21, exciter vibration data is obtained. The exciter vibration data indicates data reflecting the vibration case of the exciter of the vibration screen, which may, for example, come from one or more exciter sensors mounted on the exciter. In a case where a plurality of exciter sensors are provided on the exciter, obtaining the exciter vibration data may include obtaining data of each exciter sensor. In some implementations, vibration determination and fault evaluation may be performed separately based on vibration data of each exciter sensor. The exciter vibration data may include data such as acceleration, velocity, displacement, and the like. In a preferred solution of the present disclosure, the exciter vibration data is exciter acceleration data, and said exciter acceleration data reflects an acceleration of a power component of the exciter.

Collecting acceleration data as initial analysis data has the advantage that acceleration sensors are usually highly sensitive to vibration responses, enabling the detection of small vibration changes, which helps detect potential issues at an early stage. At the same time, acceleration sensors tend to have small volume and high integration, which is easy to install and maintain.

In step S12, it is determined whether the screen body vibration is abnormal based on said screen body vibration data. Various methods can be carried to analyze said screen body vibration data and determine whether the screen body vibration is abnormal, for example, time-domain analysis, frequency-domain analysis, or calculation of statistical features like mean, standard deviation and so on for analyzing, etc. A preferred solution of this step will be given below.

In step S22, it is determined whether exciter vibration is abnormal based on said exciter vibration data. Similarly, whether the exciter vibration is abnormal is determined based on said exciter vibration data. Various methods can be carried to analyze said exciter vibration data and determine whether the screen body vibration is abnormal, for example, time-domain analysis, frequency-domain analysis, or calculation of statistical features like mean, standard deviation and so on for analyzing, etc. A preferred solution of this step will be given below.

For steps S11, S12, S21 and S22, the order described above is not mandatory, and it is sufficient that step S12 is performed after step S11 and step S22 is performed after step S21.

In step S3, when the screen body vibration or the exciter vibration is abnormal, it is determined that the vibration screen has a fault. The screen body and exciter are the main components of the vibration screen, by collecting and analyzing data from these two main components respectively, the working state of the vibration screen can be effectively monitored, and the accuracy and response speed of fault detection can be improved.

The vibration of the vibration screen body occurs in a three-dimensional space as a complex motion. In the example of an elliptical vibration screen, its motion trajectory includes both an elliptical trajectory, for example in a vertical plane, and superimposed reciprocating swing motion in a horizontal direction perpendicular to the vertical plane. In order to more effectively determine the vibration case of the screen body, the present disclosure proposes, preferably, obtaining the screen body vibration data preferably includes obtaining first acceleration data from the screen body sensor, wherein said first acceleration data reflects an acceleration of the screen body in a plane, and obtaining second acceleration data from the screen body sensor, said second acceleration data reflects an acceleration of the screen body in a swing direction perpendicular to said plane. In this way, when performing vibration analysis, the vibration of the three-dimensional can be decomposed into vibration in said plane and reciprocating swing in the direction perpendicular to the plane, so as to more accurately determine the swing abnormality.

Said plane may be a plane of any direction. Wherein said first acceleration data may be from a screen body acceleration sensor. For example, acceleration data (ax, ay, az) reflecting acceleration in three directions of xyz can be obtained from the screen body acceleration sensor, while the first acceleration data may be (ax, ay) data of which, and the second acceleration data is az data of which. In some embodiments, said plane is a plane arranged in a vertical direction. In other embodiments, said plane may be an obliquely arranged plane.

The motion trajectory described in the present disclosure may be a motion trajectory of a point at which the sensor is positioned, or may be a motion trajectory of another point obtained by conversion, for example, the motion trajectory of the mass center or geometric center of the sensor.

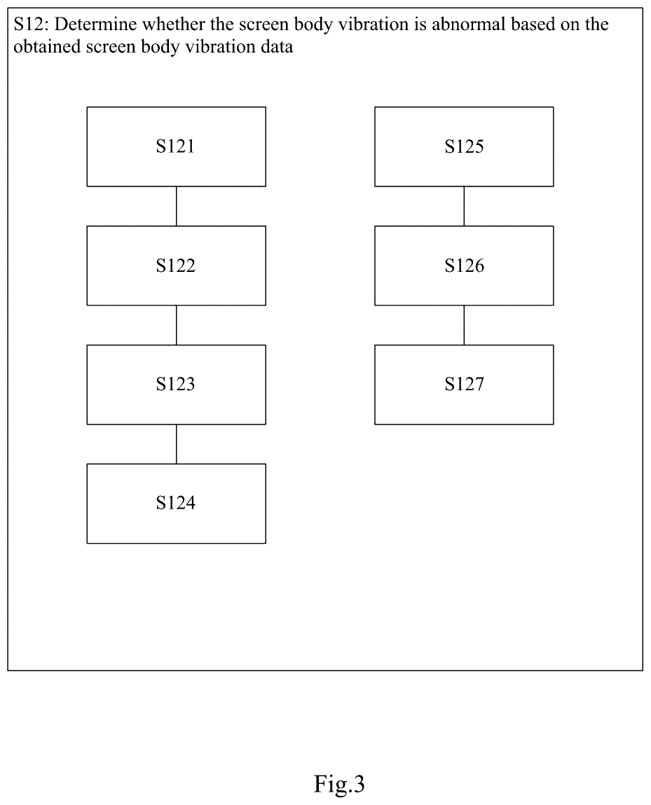

Referring to FIG. 3, the step of determining whether the screen body vibration is abnormal based on said screen body vibration data, that is, the step S12 mentioned earlier, may include the following steps: S121: converting said first acceleration data into screen body vibration position data; S122: obtaining a motion trajectory of the screen body in said plane based on said screen body vibration position data; S123: obtaining trajectory parameter data from said motion trajectory; S124: said trajectory parameter data is compared with a corresponding trajectory parameter threshold, and if said trajectory parameter data exceeds the corresponding trajectory parameter threshold, it is determined that said vibration screen has a fault.

In step S121, said first acceleration data is converted into screen body vibration position data. Preferably, converting said first acceleration data into screen body vibration position data includes integrating said first acceleration data twice to obtain screen body vibration position data. Specifically, for example, numerical integration methods such as the rectangular method, trapezoidal method, or higher-order methods can be used to perform the first integration on the acceleration signal to obtain the velocity signal. The velocity signal is numerically integrated again, and the integrated result is the vibration position data of the screen body.

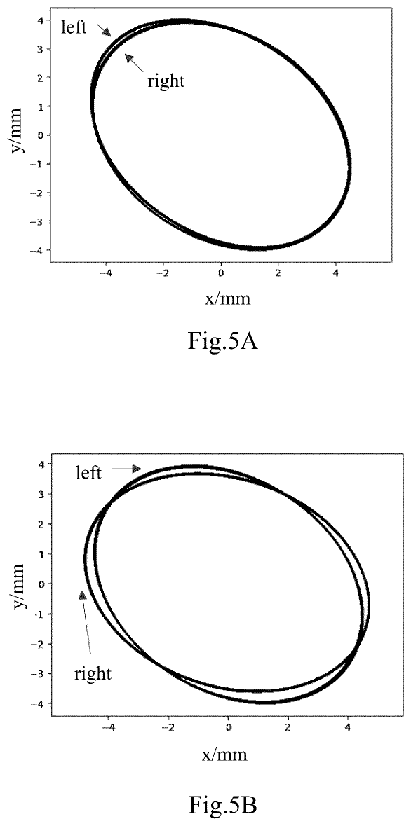

In step S122, the motion trajectory of the screen body in said plane is obtained based on said screen body vibration position data. The screen body vibration position data can be used to determine the actual position of the screen body at each time point, so as to obtain the motion trajectory of the screen body in the plane. Optionally, the monitoring system and the monitoring method of the present disclosure may include components and steps of visualizing the calculated trajectory data, respectively, to visually display the vibration of the screen body. For example, the exemplary elliptical motion trajectory of the screen body in FIGS. 5A and 5B in the x-y plane may be shown.

In Step S123, trajectory parameter data is obtained from said motion trajectory. Said trajectory parameter is a parameter capable of reflecting a trajectory feature. For example, in the case that the vibration screen is subjected to elliptically vibrated, the trajectory parameter data may include ellipse major axis dimensions, ellipse minor axis dimensions and ellipse inclination angle. The major axis of the ellipse is a straight-line segment passing through the center of the ellipse with endpoints are located at the farthest two points of the ellipse, and the minor axis of the ellipse is a straight-line segment passing through the center of the ellipse with endpoints are located at the nearest two points of the ellipse. The ellipse inclination angle represents the degree of inclination of the ellipse, and particularly may be the angle of the major axis of the ellipse with respect to a reference line, such as a horizontal reference line. In the case that the vibration screen is subjected to circular vibration, the trajectory parameter data may include radii measured at different angular positions, etc.

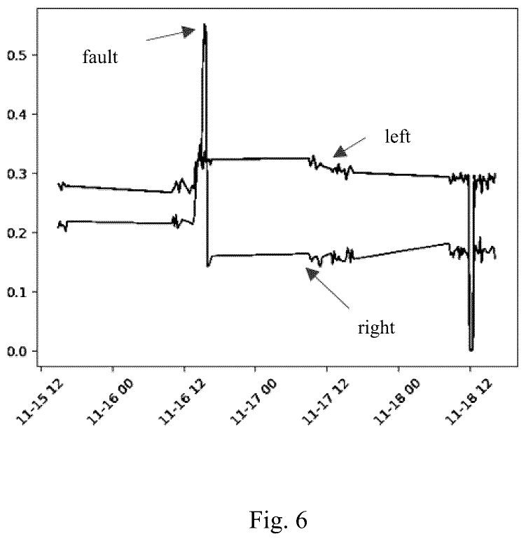

In step S124, said trajectory parameter data is compared with a corresponding trajectory parameter threshold, and if said trajectory parameter data exceeds the corresponding trajectory parameter threshold, it is determined that the vibration screen has a fault. For example, the ellipse major axis dimension, the ellipse minor axis dimension, and the ellipse inclination angle can be compared with the ellipse major axis dimension threshold, the ellipse minor axis dimension threshold, and the ellipse inclination angle threshold, respectively, and if one of the trajectory parameter data exceeds the threshold, it is determined that the vibration screen has a fault. In the example of FIG. 6, the data from the left sensor and the right sensor of the screen body both show an abnormal situation that the ellipse major axis dimension exceeds the threshold.

Through the aforementioned steps, vibration monitoring using trajectory parameter enables accurate fault identification.

However, in the present disclosure, the “threshold” may represent a single threshold, or may include an upper threshold and a lower threshold. Taking the ellipse major axis dimension as an example, the ellipse major axis dimension threshold may include an upper ellipse major axis dimension threshold and a lower ellipse major axis dimension threshold, when the ellipse major axis dimension is higher than the upper ellipse major axis dimension threshold or lower than the lower ellipse major axis dimension threshold, it is considered that the threshold has exceeded.

Alternatively, in step S12 for determining whether the screen body vibration is abnormal based on said screen body vibration data, before the step S121, may further include a step of preprocessing the screen body vibration data. Preprocessing the screen vibration data may include, for example, excluding data from the start and stop phases of the equipment to remove misleading signals. In addition, preprocessing can also include, for example, removing noise by filtering, such as using a low-pass filter to eliminate high-frequency noise higher than the operating frequency of the vibration screen, or using a band-pass filter to retain signals related to the operating frequency of the vibration screen while removing other frequency components. Through data preprocessing, the accuracy and reliability of subsequent data analysis can be improved, and a clear and accurate data base can be provided for the condition monitoring of vibration screen.

Optionally, in the step S12 of determining whether the vibration of the screen body is abnormal based on the vibration data of the screen body, it may further include comparing the trajectory parameter data in synchronization, and if the synchronization of the trajectory parameter data exceeds the synchronization threshold, it is determined that the vibration of the screen body is abnormal. For example, the trajectory parameter data from different screen body sensors can be compared for synchronization, as shown in FIG. 5A, if the synchronization of the trajectory parameter data from the left and right screen body sensors satisfies a condition, for example, does not exceed a preset threshold, the screen body vibration is considered normal. If, as shown in FIG. 5B, the synchronization of the trajectory parameter data from the two left and right screen body sensors exceeds a preset threshold, it is determined that the screen vibration is abnormal. In addition, the trajectory parameter data measured in different time periods can be compared in synchronization, and if the synchronization of the trajectory parameter data exceeds the synchronization threshold, it is determined that the screen body vibration is abnormal.

As previously described, in a preferred implementation, in addition to obtaining first acceleration data reflecting an acceleration of the screen body in a plane, obtaining the screen body vibration data further includes obtaining second acceleration data from the screen body sensor, said second acceleration data reflecting an acceleration of the screen body in a swing direction perpendicular to said plane. Said second acceleration data may be from a screen body acceleration sensor. Referring to FIG. 3, the step of determining whether the screen body vibration is abnormal based on said screen body vibration data, that is, the aforementioned step S12, may further include steps S125-S127 of processing the second acceleration data.

In step S125, the second acceleration data is converted into screen body swing position data. Preferably, converting the second acceleration data into the screen body swing position data includes integrating the first acceleration data to obtain the screen body vibration position data. Specifically, numerical integration methods such as the rectangular method, trapezoidal method, or higher-order methods can be used.

In step S126, a plurality of maximum swing positions and a plurality of initial phases of the screen body in the swing direction are obtained based on the screen body swing position data. The maximum swing position represents the maximum amplitude reached by the screen body in the swing direction, and the initial phase represents the position at the beginning of each vibration period. These two parameters can effectively reflect the vibration state of the screen body.

In step S127, it is determined whether the vibration screen is abnormal based on the plurality of maximum swing positions and the plurality of initial phases. For example, a plurality of maximum swing positions may be compared with a corresponding maximum swing position threshold, and if the maximum swing position threshold is exceeded, it may be determined that the vibration screen has a fault. A plurality of maximum swing positions can also be compared in synchronization, and if the synchronization exceeds the synchronization threshold, it is determined that the vibration screen has a fault. For example, a plurality of initial phases may be compared to corresponding initial phase thresholds, and if the initial phase thresholds are exceeded, it is determined that the vibration screen. A plurality of initial phases can also be compared in synchronization, and if the synchronization exceeds the synchronization threshold, it is determined that the vibration screen has a fault. For the synchronization comparison, data from different sensors may be compared in synchronization, or data from different time periods may be compared in synchronization.

Preferably, the specific operation of step S127 is to compare the plurality of maximum swing positions with a maximum swing threshold, and compare the plurality of initial phases in synchronization, and determine that the vibration screen has a fault if the maximum swing position exceeds the maximum swing threshold or the synchronization of the plurality of phase data is lower than the synchronization threshold. In this way, the vibration state determination of the exciter can be performed simply and most efficiently.

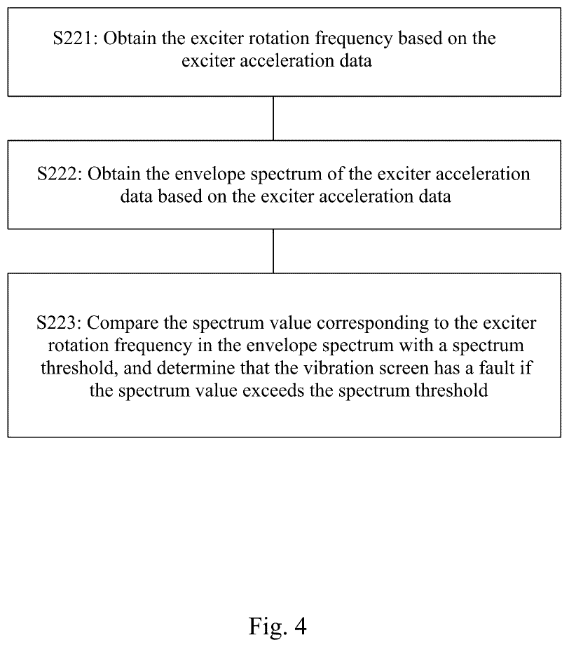

As mentioned above, the present disclosure proposes the method of monitoring the state of the vibration screen, includes a step S21: obtaining vibration data of the exciter and a step S22: determining whether the screen body vibration is abnormal based on the vibration data of the exciter. FIG. 4 shows a preferred operation of step S22, in which the exciter vibration data is exciter acceleration data, and the step S22 specifically includes the following steps S221 to S223.

In step S221, the exciter rotation frequency is obtained based on the exciter acceleration data. The exciter rotation frequency refers to the number of revolutions per second of the rotating part of the exciter, expressed in Hertz (Hz). Preferably, during the monitoring, the exciter frequency is calculated in real time based on the exciter acceleration data. Preferably, the exciter rotational speed is calculated from the exciter acceleration data, and thus the exciter rotation frequency is calculated.

In step S222, obtaining an envelope spectrum of the exciter acceleration data based on the exciter acceleration data. For example, the step may include performing envelope extraction on the acceleration signal, obtaining an envelope waveform, and performing a fast Fourier transform (FFT) on the envelope signal to convert the signal from the time domain to the frequency domain. The result of fast Fourier transform (FFT) is the envelope spectrum, which shows the distribution of different frequency components in the vibration signal. FIG. 7 shows the original exciter acceleration data in the left diagram, and shows the waveform and spectrum of the envelope obtained by the change in the right diagram. Optionally, the monitoring system and the monitoring method of the present disclosure may include components and steps of visualizing the envelope waveform and the envelope spectrum as shown in FIG. 7, respectively, to visually display the vibration situation of the screen body.

The order of steps S221 and S222 may be interchanged.

In step S223, a spectrum value corresponding to the exciter rotation frequency in the envelope spectrum is compared with a spectrum threshold, and if the spectrum value exceeds the spectrum threshold, it is determined that the vibration screen has a fault. For this step, in view of the fact that there are multiple spectra in the envelope spectrum, a spectral value corresponding to the exciter rotation frequency is selected and compared to a spectral threshold. If the frequency spectrum value exceeds the frequency spectrum threshold, for example, is lower than the lower frequency spectrum threshold or higher than the upper frequency spectrum threshold, it is determined that the vibration screen has a fault. Through this method, the fault of the vibration screen can be accurately identified while being simple and efficient.

Preferably, in an embodiment in which the exciter has a bearing for supporting the rotation of the eccentric wheel, the step S223 may further include an additional step: comparing spectral values in the envelope spectrum corresponding to the failure frequencies of each component of the exciter bearing with respective spectral thresholds, and determining that the vibration screen has a fault if any of the spectral values exceeds the spectral threshold. The failure frequency of each component may be obtained by multiplying the failure frequency coefficient of each component by the rotation frequency.

Each component of the bearing may include one or more of the following: an outer ring, an inner ring, a rolling body, a cage, and the like.

Taking a bearing having an outer ring, an inner ring, a rolling body, and a cage as an example, respective failure frequency coefficients can be preset for the outer ring, the inner ring, the rolling body, and the cage of the bearing based on bearing structural parameters and the like, and the respective failure frequencies of the outer ring, the inner ring, the rolling body, and the cage can be obtained by multiplying the respective failure frequency coefficients with the rotation frequency. Then, the spectrum value corresponding to each component of the bearing in the envelope spectrum is compared with a spectrum threshold, and if the spectrum value exceeds the spectrum threshold, it is determined that the vibration screen has a fault, and it is possible to preliminarily determine which component of the bearing is the specific source of the fault through this.

The following table shows the failure frequency coefficients for exemplary bearing components. In which, other coefficients may be preset for the bearing components.

| | fault frequency |
|---|---|
| component name | coefficient |
| outer ring | 17.71 |
| inner ring | 20.28 |
| rolling body | 7.31 |
| cage | 0.46 |

Through the additional step of step S223, not only can the fault of the exciter of the vibration screen be identified by a simple and effective way, but also the specific source of the fault can be preliminarily determined. This improves detection and maintenance efficiency and reduces costs.

In step S22, optionally, before step S221, the method further includes preprocessing the exciter vibration data. Preprocessing the exciter vibration data may include, for example, excluding data from the start and stop phases of the device to remove misleading signals. In addition, preprocessing can also include, for example, removing noise by filtering, such as using a low-pass filter to eliminate high-frequency noise higher than the operating frequency of the vibration screen, or using a band-pass filter to retain signals related to the operating frequency of the vibration screen while removing other frequency components. Through data preprocessing, the accuracy and reliability of subsequent data analysis can be improved, and a clear and accurate data base can be provided for the condition monitoring of vibration screen.

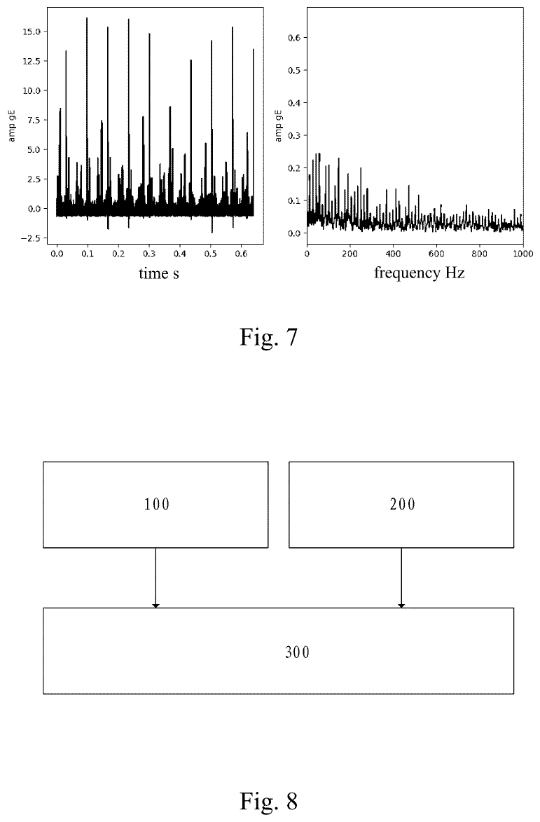

FIG. 8 illustrates the vibration screen condition monitoring system of the present disclosure. The condition monitoring system includes: one or more screen body sensors 100 located on the screen body of the vibration screen; one or more exciter sensors 200 located on the exciter of the vibration screen; a state determination unit 300 that receives screen body vibration data from the one or more screen body sensors and receives exciter vibration data from the one or more exciter sensors, wherein the state determination unit determines whether the screen body vibration is abnormal based on the screen body vibration data and determines whether the exciter vibration is abnormal based on the exciter vibration data, and determines that the vibration screen has a fault when either the screen body vibration or the exciter vibration is abnormal. The state determination unit may specifically determine whether the exciter vibration is abnormal according to the method of any one of the above-described embodiments.

The exemplary implementation of the scheme proposed in present disclosure has been described in detail above with reference to the preferred embodiments. However, those skilled in the art can understand that various variations and modifications can be made to the above specific embodiments without departing from the concept of this disclosure, and various technical features and structures proposed in this disclosure can be combined in various ways without exceeding the protection scope of this disclosure, which is determined by the appended claims.

1. A method of monitoring a condition of a vibration screen, the method comprising:
obtaining screen body vibration data;
obtaining exciter vibration data;
determining whether a screen body vibration is abnormal based on the screen body vibration data;
determining whether an exciter vibration is abnormal based on the exciter vibration data; and
determining that the vibration screen has a fault when either the screen body vibration or the exciter vibration is abnormal.

2. The method as claimed in claim 1, wherein:
obtaining the screen body vibration data comprises obtaining first acceleration data from a screen body sensor, wherein the first acceleration data reflects the acceleration of the screen body in a plane; and
determining whether the screen body vibration is abnormal based on the screen body vibration data comprises:
converting the first acceleration data into screen body vibration position data;
obtaining the motion trajectory of the screen body in said plane based on the screen body vibration position data;
obtaining trajectory parameter data from the motion trajectory; and
comparing the trajectory parameter data with corresponding trajectory parameter thresholds and determining that the vibration screen has a fault if the trajectory parameter data exceeds the corresponding trajectory parameter thresholds.

3. The method as claimed in claim 2, wherein the trajectory parameter data comprises an ellipse major axis dimension, an ellipse minor axis dimension, and an ellipse inclination angle.

4. The method as claimed in claim 2, wherein converting the first acceleration data into the screen body vibration position data comprises integrating the first acceleration data twice to obtain the screen body vibration position data.

5. The method as claimed in claim 2, wherein:
obtaining the screen body vibration data comprises obtaining a second acceleration data from the screen body sensor, wherein the second acceleration data reflects the acceleration of the screen body in a swing direction perpendicular to the plane; and
determining whether the screen body vibration is abnormal based on the screen body vibration data comprises:
converting the second acceleration data into screen body swing position data;
obtaining a plurality of maximum swing positions and initial phases of the screen body in the swing direction based on the screen body swing position data; and
determining whether the vibration screen has a fault based on the plurality of maximum swing positions and initial phases.

6. The method as claimed in claim 1, wherein determining whether the vibration screen has a fault based on the plurality of maximum swing positions and initial phases comprises:
comparing the plurality of maximum swing positions with a maximum swing threshold,
comparing the plurality of initial phases in synchronization, and
determining that the vibration screen has a fault if the maximum swing position exceeds the maximum swing threshold or synchronization of the phase data is lower than a synchronization threshold.

7. The method as claimed in claim 1, wherein the exciter vibration data is exciter acceleration data from an exciter sensor.

8. The method as claimed in claim 7, wherein determining whether the exciter vibration is abnormal based on the exciter vibration data comprises:
obtaining an exciter rotation frequency based on the exciter acceleration data;
obtaining an envelope spectrum of the exciter acceleration data based on the exciter acceleration data; and
comparing a spectrum value corresponding to the exciter rotation frequency in the envelope spectrum with a spectrum threshold and determining that the vibration screen has a fault if the spectrum value exceeds a spectrum threshold.

9. The method as claimed in claim 1, wherein:
determining whether the screen body vibration is abnormal based on the screen body vibration data comprises preprocessing the screen body vibration data, and/or
determining whether the exciter vibration is abnormal based on the exciter vibration data comprises preprocessing the exciter vibration data.

10. A vibration screen condition monitoring system comprising:
one or more screen body sensors located on the screen body of the vibration screen;
one or more exciter sensors located on the exciter of the vibration screen; and
a state determination unit that receives screen body vibration data from the one or more screen body sensors and receives exciter vibration data from the one or more exciter sensors, wherein the state determination unit determines whether the screen body vibration is abnormal based on the screen body vibration data and determines whether the exciter vibration is abnormal based on the exciter vibration data, and determines that the vibration screen has a fault when either the screen body vibration or the exciter vibration is abnormal.
